(19) United States
(12) Patent Application Publication
(10) Pub. No.: US 2024/0244229 A1
(43) Pub. Date: Jul. 18, 2024

(54) SYSTEMS AND METHODS FOR PREDICTIVE CODING

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, CANTON, GA (US)

(73) Assignee: OP Solutions, LLC, Amherst, MA (US)

(21) Appl. No.: 18/621,555

(22) Filed: Mar. 29, 2024

Related U.S. Application Data
(63) Continuation of application No. PCT/US22/45740, filed on Oct. 5, 2022.
(60) Provisional application No. 63/252,266, filed on Oct. 5, 2021.

(51) Int. Cl. H04N 19/154; H04N 19/136; H04N 19/169; H04N 19/172; H04N 19/50; H04N 19/65

(52) U.S. Cl. CPC H04N 19/154; H04N 19/136; H04N 19/172; H04N 19/188; H04N 19/50; H04N 19/65

(57) ABSTRACT

A system for predictive coding includes a computing device configured to receive an input video, determine a quality impact as a function of the input video, wherein determining the quality impact further comprises identifying a frame drop indicator as a function of the input video, and determining the quality impact as a function of the frame drop indicator, and produce an encoded video as a function of the quality impact and an encoding process.

### CROSS REFERENCE TO RELATED APPLICATIONS

This application is a continuation of International Application PCT/US22/45740 filed on Oct. 5, 2022, and entitled SYSTEMS AND METHODS FOR PREDICTIVE CODING, which claims the benefit of priority to U.S. Provisional patent application Ser. No. 63/252,266 filed on Oct. 5, 2021 and entitled “SYSTEMS AND METHODS FOR PREDICTIVE CODING,” the disclosures of each of which is hereby incorporated by reference in its entirety.

### FIELD OF THE INVENTION

The present invention generally relates to the field of video encoding and decoding. In particular, the present invention is directed to systems and methods for organizing and searching a video database.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, case of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

In an aspect, a system for predictive coding includes a computing device configured to receive an input video, determine a quality impact as a function of the input video, wherein determining the quality impact further comprises identifying a frame drop indicator as a function of the input video, and determining the quality impact as a function of the frame drop indicator, and produce an encoded video as a function of the quality impact and an encoding process.

In another aspect, a method for predictive coding includes receiving, by a computing device, an input video, determining, by the computing device, a quality impact as a function of the input video, wherein determining the quality impact further comprises identifying a frame drop indicator as a function of the input video, and determining the quality impact as a function of the frame drop indicator, and producing, by the computing device, an encoded video as a function of the quality impact and an encoding process.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a video coding system;

FIG. 2 is a block diagram illustrating an exemplary embodiment of a video coding for machines system;

FIG. 3 is a block diagram illustrating an exemplary embodiment of a system for predictive coding;

FIG. 4 is a diagrammatic representation illustrating an exemplary embodiment of a video distribution system;

FIG. 5 is a diagrammatic representation illustrating an exemplary embodiment of a playback system;

FIG. 6 is a diagrammatic representation illustrating an exemplary embodiment of frame dependencies;

FIG. 7 is a flow diagram illustrating an exemplary embodiment of a method for predictive coding;

FIG. 8 is a block diagram illustrating an exemplary embodiment of a video decoder;

FIG. 9 is a block diagram illustrating an exemplary embodiment of a video encoder; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

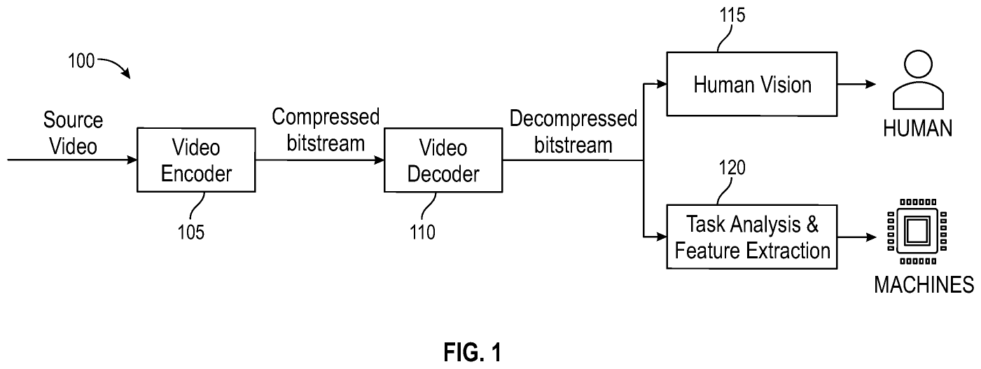

In many applications, such as surveillance systems with multiple cameras, intelligent transportation, smart city applications, and/or intelligent industry applications, traditional video coding may require compression of large number of videos from cameras and transmission through a network to machines and for human consumption. Subsequently, at a machine site, algorithms for feature extraction may applied typically using convolutional neural networks or deep learning techniques including object detection, event action recognition, pose estimation and others. FIG. 1 shows an exemplary embodiment of a standard VVC coding/decoding system applied for machines. The system 100 includes a video encoder 105 which provides a compressed bitstream over a channel to video decoder 110 which decompresses the bitstream and, preferably, provides video for human vison 115 and task analysis and feature extraction 120 suitable for machine applications. Conventional approaches unfortunately, may require a massive video transmission from multiple cameras, which may take significant time for efficient and fast real-time analysis and decision-making. In embodiments, a VCM approach may resolve this problem by both encoding video and extracting some features at a transmitter site and then transmitting a resultant encoded bit stream to a VCM decoder. At a decoder site video may be decoded for human vision and features may be decoded for machines.

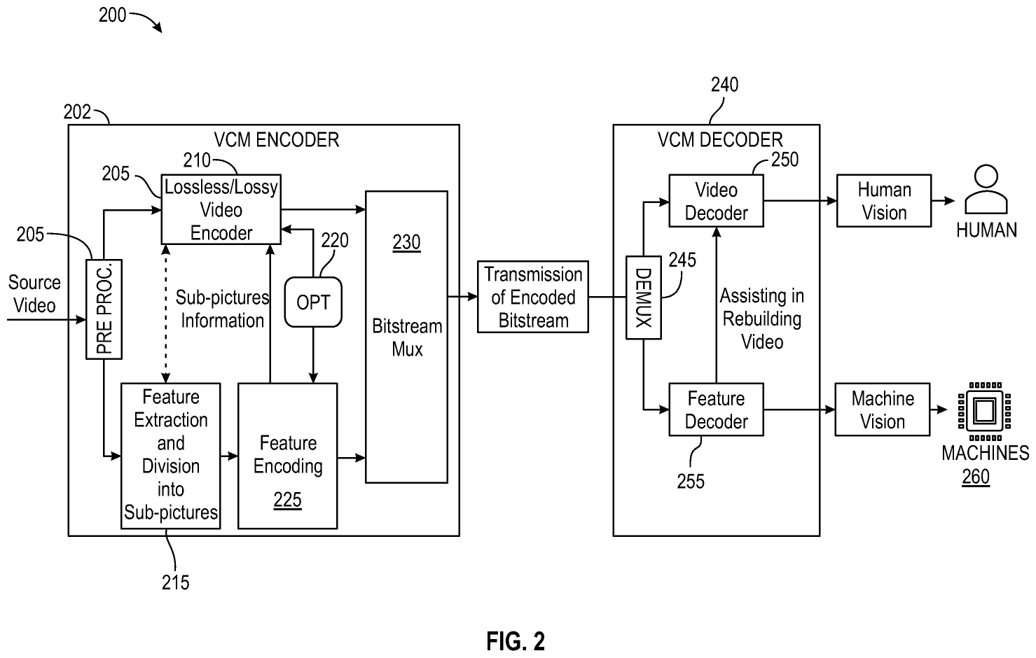

Referring now to FIG. 2, an exemplary embodiment of encoder for video coding for machines (VCM) is illustrated. VCM encoder may be implemented using any circuitry including without limitation digital and/or analog circuitry; VCM encoder may be configured using hardware configuration, software configuration, firmware configuration, and/or any combination thereof. VCM encoder may be implemented as a computing device and/or as a component of a computing device, which may include without limitation any computing device as described below. In an embodiment, VCM encoder may be configured to receive an input video and generate an output bitstream. Reception of an input video may be accomplished in any manner described below. A bitstream may include, without limitation, any bitstream as described below. It will also be appreciate that, as used herein, the term video may not only includes content captured by an optical device such as a camera, but also data streams from other devices such as LIDAR or RADAR, features of such captured content, generated content, such as from video games and virtual reality systems, and the like.

VCM encoder may include, without limitation, a pre-processor 205, a video encoder 210, a feature extractor 215, an optimizer 220, a feature encoder 225, and/or a multiplexor 230. Pre-processor 205 may receive input video stream and parse out video, audio and metadata sub-streams of the stream. Pre-processor 205 may include and/or communicate with decoder as described in further detail below; in other words, Pre-processor 205 may have an ability to decode input streams. This may allow, in a non-limiting example, decoding of an input video, which may facilitate downstream pixel-domain analysis.

Further referring to FIG. 2, VCM encoder may operate in a hybrid mode and/or in a video mode; when in the hybrid mode VCM encoder may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor.

Still referring to FIG. 2, video encoder may include without limitation any video encoder as described in further detail below. When VCM encoder is in hybrid mode, VCM encoder may send unmodified input video to video encoder and a copy of the same input video, and/or input video that has been modified in some way, to feature extractor. Modifications to input video may include any scaling, transforming, or other modification that may occur to persons skilled in the art upon reviewing the entirety of this disclosure. For instance, and without limitation, input video may be resized to a smaller resolution, a certain number of pictures in a sequence of pictures in input video may be discarded, reducing framerate of the input video, color information may be modified, for example and without limitation by converting an RGB video might be converted to a grayscale video, or the like.

Still referring to FIG. 2, video encoder 210 and feature extractor 215 are preferably connected and might exchange useful information in both directions. For example, and without limitation, video encoder 210 may transfer motion estimation information to feature extractor 215, and vice-versa. Video encoder 210 may provide Quantization mapping and/or data descriptive thereof based on regions of interest (ROI), which video encoder and/or feature extractor may identify, to feature extractor, or vice-versa. Video encoder 210 may provide to feature extractor data describing one or more partitioning decisions based on features present and/or identified in input video, input signal, and/or any frame and/or subframe thereof; feature extractor may provide to video encoder data describing one or more partitioning decisions based on features present and/or identified in input video, input signal, and/or any frame and/or subframe thereof. Video encoder feature extractor may share and/or transmit to one another temporal information for optimal group of pictures (GOP) decisions. Each of these techniques and/or processes may be performed, without limitation, as described in further detail below.

With continued reference to FIG. 2, feature extractor 215 may operate in an offline mode or in an online mode. Feature extractor 215 may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor by a remote machine in real time or at some point before extraction.

Still referring to FIG. 2, feature encoder 225 is configured for encoding a feature signal, for instance and without limitation as generated by feature extractor. In an embodiment, after extracting the features feature extractor may pass extracted features to feature encoder. Feature encoder may use entropy coding and/or similar techniques, for instance and without limitation as described below, to produce a feature stream, which may be passed to multiplexor. Video encoder and/or feature encoder may be connected via optimizer; optimizer may exchange useful information between those video encoder and feature encoder. For example, and without limitation, information related to codeword construction and/or length for entropy coding may be exchanged and reused, via optimizer, for optimal compression.

In an embodiment, and continuing to refer to FIG. 2, video encoder 210 may produce a video stream; video stream may be passed to multiplexor. Multiplexor 230 may multiplex video stream with a feature stream generated by feature encoder; alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder is in video mode, VCM encoder may use video encoder for both video and feature encoding. Feature extractor may transmit features to video encoder; the video encoder may encode features into a video stream that may be decoded by a corresponding video decoder. It should be noted that VCM encoder may use a single video encoder for both video encoding and feature encoding, in which case it may use different set of parameters for video and features; alternatively, VCM encoder may two separate video encoders, which may operate in parallel.

Still referring to FIG. 2, system may include and/or communicate with, a VCM decoder 240. VCM decoder and/or elements thereof may be implemented using any circuitry and/or type of configuration suitable for configuration of VCM encoder as described above. VCM decoder may include, without limitation, a demultiplexor 245. Demultiplexor 245 may operate to demultiplex bitstreams if multiplexed as described above; for instance and without limitation, demultiplexor may separate a multiplexed bitstream containing one or more video bitstreams and one or more feature bitstreams into separate video and feature bitstreams.

Continuing to refer to FIG. 2, VCM decoder may include a video decoder 250. Video decoder 250 may be implemented, without limitation in any manner suitable for a decoder as described in further detail below. In an embodiment, and without limitation, video decoder 250 may generate an output video, which may be viewed by a human or other creature and/or device having visual sensory abilities.

Still referring to FIG. 2, VCM decoder may include a feature decoder 255. In an embodiment, and without limitation, feature decoder may be configured to provide one or more decoded data to a machine. Machine may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder 202 and/or VCM decoder 240 may be designed and/or configured to perform any method, method step, or sequence of method steps in any embodiment described in this disclosure, in any order and with any degree of repetition. For instance, each of VCM encoder and/or VCM decoder may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder and/or VCM decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

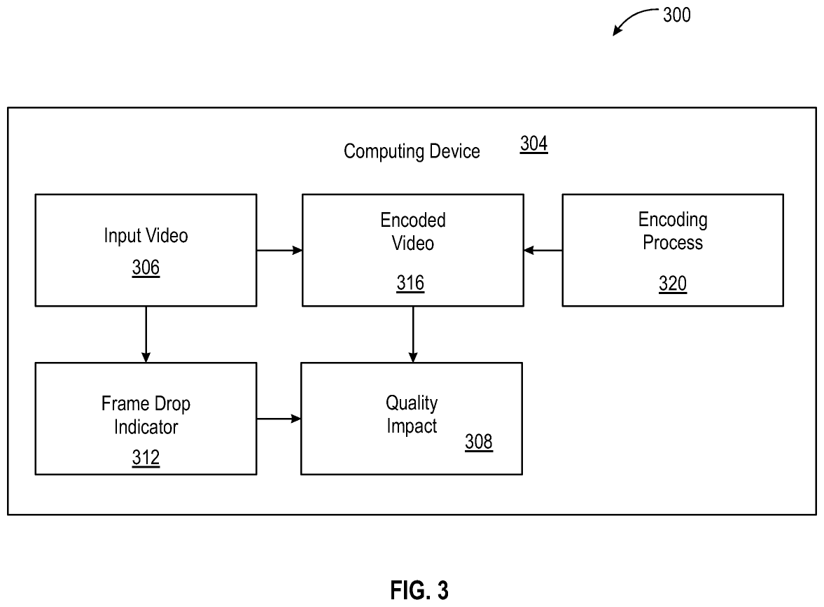

Now referring to FIG. 3, a system 300 for predictive coding is illustrated. System 300 includes a computing device 304. System includes a computing device 304. Computing device 304 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device 304 may include a single computing device operating independently, or may include two or more computing device operating in concert, in parallel, sequentially or the like; two or more computing devices may be included together in a single computing device or in two or more computing devices. Computing device 304 may interface or communicate with one or more additional devices as described below in further detail via a network interface device. Network interface device may be utilized for connecting computing device 304 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 304 may include but is not limited to, for example, a computing device or cluster of computing devices in a first location and a second computing device or cluster of computing devices in a second location. Computing device 304 may include one or more computing devices dedicated to data storage, security, distribution of traffic for load balancing, and the like. Computing device 304 may distribute one or more computing tasks as described below across a plurality of computing devices of computing device, which may operate in parallel, in series, redundantly, or in any other manner used for distribution of tasks or memory between computing devices. Computing device 304 may be implemented using a “shared nothing” architecture in which data is cached at the worker, in an embodiment, this may enable scalability of system 100 and/or computing device.

With continued reference to FIG. 3, computing device 304 may be designed and/or configured to perform any method, method step, or sequence of method steps in any embodiment described in this disclosure, in any order and with any degree of repetition. For instance, computing device 304 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 304 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 3, computing device is configured to receive an input video 304. Input video 304 may include any input video 304 as described above, in reference to FIGS. 1-2. Input video 304 may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 3, computing device 304 is configured to determine a quality impact 308 as a function of the video input 304. As used in this disclosure a “quality impact” is an element of data representing the impact of frame being dropped and/or removed with respect to the quality of experience a user may notice and/or be bothered by. For example, and without limitation, quality impact may include indicate a quality of experience such as but not limited to an experience associated with a user noticing and/or being bothered by distortions caused by one or more frame drops, error concealments, amounts of concealment, types of concealment, and the like thereof. In an embodiment and without limitation, quality impact 308 may denote that a user may perceive blocking and/or patches in a played video as a function of fast moving content such as a sports action video. In another embodiment, and without limitation, quality impact 308 may denote that a user may not notice any difference as a function of static content such as a slow moving video and/or video conference calls. In an embodiment, and without limitation, quality impact 308 may denote that a user experience and/or quality of the video may be dropped at the data center, in the network nodes, and/or at the consumer device. In another embodiment, and without limitation, impact quality 308 may depend on video content, frame dependencies, magnitude of dependencies, and/or error concealment, wherein knowledge of this impact may allow elements of a video distribution system to make optimal decisions. In an embodiment, and without limitation, quality impact 304 may identify the impact of not decoding a frame and/or dropping a frame on the experience of end users.

Still referring to FIG. 3, quality impact 308 may be determined as a function of an SEI message syntax. For example, and without limitation, quality impact 308 may be determined as a function of an SEI message syntax comprising:

| | |
|---|---|
| frame_quality_impact_information( payloadSize ) { | Descriptor |
| fqi_qoe_impact | u(8) |
| fqi_needs_error_concealment | u(1) |
| if( fqi_needs_error_concelment ) { | |
| fqi_concealment_type | u(7) |
| } | |
| if( fqi_concelment_type > 0 ) { | |
| fqi_source_frame_count_minus1 | u(3) |
| fqi_ reference_frame_generation_type | u(3) |
| for(i=0; i <= fqi_source_frame_count_minus1; i++){ | u(1) |
| fqi_frame_index | u(4) |
| } | |
| } | |
| } | |

Still referring to FIG. 3, computing device 304 is configured to identify a frame drop indicator 312 as a function of input video 304. As used in this disclosure a “frame drop indicator” is an element of data representing information necessary to signal frame dropping. For example, and without limitation, the impact of frame dropping may be included in video bitstreams using structures such as supplementary enhancement information (SEI) messages in VVC and HEVC. In an embodiment, and without limitation, frame drop indicator 312 may allow a decoding device to make frame dropping decisions. In another embodiment, and without limitation, frame drop indicator 312 may signal a network device to parse a packet to identify data necessary to signal frame dropping. In an embodiment, and without limitation, frame drop indicator 312 may include a fqi_qoe_impact value that represents an impact of dropping the frame on end user quality of experience. In an embodiment, and without limitation, this can be mapped similar to an equivalent of subjective mean opinion score (MOS) values that signal subjective quality. In another embodiment, and without limitation, the value can also be mapped to a small set of values with specific descriptive quality impacts. Alternatively, the value can signal a drop of certain MOS score. For example, the value can signal drop in MOS of fqi_qoe_impact*0.05. This value can be easily interpreted by intermediate nodes to make frame drop decisions that take content dependencies and user impact into considerations. In an embodiment, and without limitation, fqi_qoe_impact may be represented as a function of a numerical range of values, wherein the range may include a plurality of numbers that each represent a subjective measure of impact on user quality. For example, and without limitation, fqi_qoe_impact may be represented as a function of

| fqi_qoe_impact | Dependent Frames |
|---|---|
| 0 | no impact on user quality. User |
| | do not notice the drop |
| 1 | |
| 2 | |
| 3 | |
| 4 | |
| 5 | |
| 6 | |
| 7 | will significantly impact user |
| | quality and/or the user will |
| | likely notice the drop |

wherein 0 may represent that a dependent frame includes no impact on user quality and/or the user does not notice a drop, and wherein a value of 7 may represent that a dependent frame will significantly impact user quality and/or the user will likely notice the drop.

Still referring to FIG. 3, frame drop indicator 308 may include a frame dependency. As used in this disclosure a “frame dependency” is an element of data representing that a first frame is dependent on a second frame to be decoded. In an embodiment, frame dependency may include an I-frame, wherein an I-frame is a frame of a video that can be correctly decoded without depending on any other frame. In another embodiment, and without limitation, frame dependency may include a P-frame, wherein a P-frame is a predictively coded frame that depends on one or more frames that are previously decoded. In an embodiment, and without limitation, a P-frame usually depends on frames that are temporally in the past. In another embodiment, and without limitation, frame dependency may include a B-frame, wherein a B-frame is a predictively coded frame that depends on one or more frames that are previously decoded. In an embodiment, and without limitation, a B-frame usually depends on frames that are both temporally in the past and in the future. For example, and without limitation, to support prediction for B-frames, frames may be encoded out of order. Additionally or alternatively, computing device 304 may be configured to receive a display order. As used in this disclosure a “display order” is an order in which frames of input video is displayed to a user. For example, and without limitation, display order may denote that frames associated to input video should be represented in an order consisting of 1, 2, 3, 4, 5, 6, 7, 8. As a further non-limiting example, display order may denote that frames associated to input video should be represented in an order consisting of 3, 6, 1, 7, 4, 5, 8, 2. In an embodiment, computing device 304 may identify frame drop indicator as a function of the display order, wherein identifying is described above, in reference to FIGS. 1-2.

In an embodiment, and without limitation, computing device 304 may be configured to perform a predictive encoding protocol. A “predictive encoding protocol” is a method and/or process wherein the similarities among successive frames of a sequence are compressed such that the sequence may be compressed. In an embodiment, and without limitation, predictive encoding protocol may use predictive coding where the current frames being encoded use predictions from previously encoded frames, wherein previously encoded frames may include one or more frames that were encoded previously due to the frame dependency. In another embodiment, and without limitation, predictive encoding protocol may be used to form predictions for the current frame being decoded as a function of previously decoded frames at the receiver and/or decoder. Additionally or alternatively, and without limitation, computing device 304 may identify frame drop indicator 312 by determining a transport packet as a function of the input video. As used in this disclosure a “transport packet” is an application layer packet configured to transport and/or convey a video input. For example, and without limitation, transport packet may include one or more RTP headers and/or DASH manifest files. In an embodiment, and without limitation, computing device 304 may be configured to identify frame drop indicator 312 as a function of the transport package, wherein identifying is described above, in reference to FIGS. 1-2.

Still referring to FIG. 3, computing device 304 is configured to produce an encoded video 316 as a function of quality impact 308 and an encoding process 320. As used in this disclosure an “encoded video” is compressed and/or formatted video images and/or files. For example, and without limitation, encoded video may include one or more videos that are reduced in size and/or converted from an analog to a digital signal. In an embodiment, and without limitation, computing device 304 may be configured to initiate a frame drop protocol. As used in this disclosure a “frame drop protocol” is a process and/or method to remove one or more dependent frames from an input video. For example, and without limitation, a dependent frame that does not enhance the image quality and/or maintain image quality, may be dropped and/or removed from the encoded video to reduce a file size. As a further non-limiting example, a dependent frame that does may affect and/or deteriorate the image quality may be dropped and/or removed from the encoded video to reduce a file size. In an embodiment, and without limitation, initiating the frame drop protocol may include determining a reduced quality as a function of quality impact 308. A reduced quality may include any reduction of clarity, peak signal-t-noise ratio, structural similarity, motion-based video integrity, VMAF, SSR, ST-RRED, naturalness image quality, blind and/or referenceless image spatial quality, and/or video-BLINDS. In an embodiment, and without limitation, determining reduced quality may include determining a blurring, blocking, ringing, color bleeding, staircase noise, flickering, mosquito noise, floating, jerkiness, and the like thereof. In an embodiment, and without limitation, computing deice 104 may initiate the frame drop protocol as a function of the reduced quality.

Still referring to FIG. 3, computing device 304 may be configured to perform an error concealment. As used in this disclosure an “error concealment” is one or more processes to enhance a video quality. In an embodiment, and without limitation, computing device may perform error concealment as a function of determining a proximal frame. As used in this disclosure a “proximal frame” is a temporally close frame to the dropped frame. For example, and without limitation, proximal frame may be the temporally closest frame to the dropped frame. Computing device 304 may be configured to perform error concealment as a function of using a specific frame. As used in this disclosure a “specific frame” is a frame that is selected and/or identified by a user to be a reference frame, wherein a reference frame is a frame that may be inserted as a replacement to a dropped frame. In an embodiment, and without limitation, computing device 304 may perform error concealment as a function of replacing a dropped frame with the specific frame. Additionally or alternatively, computing device 304 may perform error concealment as a function of generating a reference frame from a plurality of specific frames. For example, and without limitation, computing device 304 may generate a reference frame as a function of combining and/or culminating a plurality of specific frames such that a new frame is produced, wherein that new frame is to be used as a reference frame. In an embodiment, and without limitation, computing device 304 may generate the reference frame as a function of averaging a plurality of specified frames. In another embodiment, and without limitation, computing device 304 may generate the reference frame as a function of a motion compensated synthesis. In another embodiment, and without limitation, computing device 104 may generate the reference frame as a function of splicing a plurality of specified frames and orienting the spliced sections to create a reference frame.

In an embodiment, and still referring to FIG. 3, network nodes may perform high speed packet processing and need efficient access to determine quality impact 308. In an embodiment, and without limitation, frame drop indicator values may be needed for server at data centers and network nodes to drop frames effectively. Such information from the SEI may be made available at the application and/or transport layer. In an embodiment, and without limitation, an RTP transmission may carry information as a function of an RTP packet header. In another embodiment, and without limitation, encrypted frames may be transmitted, wherein the frame drop indicator 312 may be included without encryption such that network nodes may be enabled to make frame drop decisions without a need for decryption keys. In an embodiment, and without limitation, RTP payload formats for video can be updated to include the frame drop indicator values in RTP packets. Similarly, protocols such as MPEG-2 transport streams can signal the frame drop indicator values in packet headers that correspond to frames. In the case of MPEG-2 transport streams, video frames may be encapsulated in a PES packet. The frame drop indicator values may be signaled in the PES_extension and/or PES_private_data. In another embodiment, is to signal the values in the adaptation field of the TS packet header. Additionally or alternatively, DASH and/or HLS type distribution formats may allow for a segment header in the manifest file to be used to signal a list of frames and the corresponding frame drop indicator values. In another embodiment, MP4 file distribution formats may allow for the frame drop indicator values to be included as a part of sample description headers. A structure such as “SampleQualityImpactBox” can be defined to signal quality impact values of all samples. For example, a search may include a search as a function of the query:

```
aligned(8) class SampleQualityImpactBox extends FullBox(‘sqib’,
version = 0, 0) {
unsigned int(32) sample_count;
for (i=1; i u sample_count; i++) {
    unsigned int(8) fqi_qoe_impact;
}
  }
```

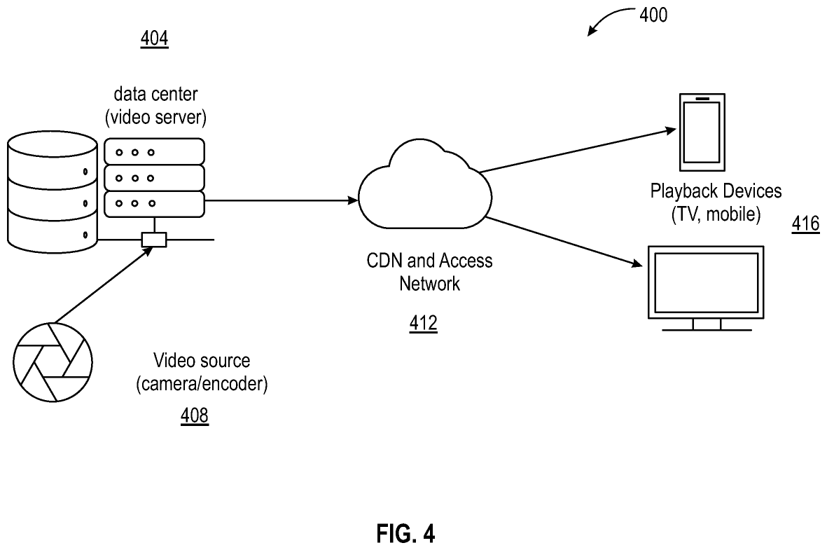

Now referring to FIG. 4, an exemplary embodiment of a video distribution system 400 is illustrated. In an embodiment, and without limitation, video distribution system 400 may include one or more systems configured to perform video streaming services for remote work and/or entertainment services. In another embodiment, and without limitation, video distribution system 400 may aid in reducing energy consumption. For example, and without limitation, video distribution system 400 may be configured to minimize an energy expenditure such that a reduced carbon footprint may be deployed during the distribution of the videos. For example, and without limitation, video distribution system 400 may reduce an average CO2 consumption of 36 g for one hour of video streamed to 24 g of CO2 for one hour of video streamed. In an embodiment, and without limitation, video distribution system 400 may include a data center 404. As used in this disclosure a “data center” is a computer-based device that is dedicated to delivering video. In an embodiment, and without limitation, data center 404 may include one or more video servers. In another embodiment, and without limitation, data center 404 may be capable of storing broadcast quality images and/or allow several users to edit stories using the images they contain simultaneously. Video distribution system 400 may include a video source 408. As used in this disclosure a “video source” is a device that produces a video signal to be displayed. In an embodiment, and without limitation, video source 408 may be configured to produce a video signal to be displayed as a function of an entertainment system. Video source 408 may include one or more cameras and/or light capturing devices. For example, and without limitation, video source 408 may include a camera, camcorder, video camera, and the like thereof. In an embodiment, and without limitation, video source 408 may include an encoder, wherein an encoder is described above in reference to FIGS. 1-3. In an embodiment, and without limitation, video distribution system 400 may include an access network 412. As used in this disclosure an “access network” is a content delivery network that allows for the quick transfer of assets needed for loading content. In an embodiment, and without limitation, access network 412 may include one or more content delivery networks capable of loading content such as but not limited to image frames, videos, video frames, and the like thereof. In an embodiment, and without limitation, access network 412 may be configured to protect against malicious attacks such as, but not limited to, distributed denial of service attacks. Additionally or alternatively, video distribution system 400 may include a playback device 416. As used in this disclosure a “playback device” is a device and/or system capable of displaying the video content. For example, and without limitation, playback device may include a television, mobile device, telephone, laptop, tablet, and the like thereof.

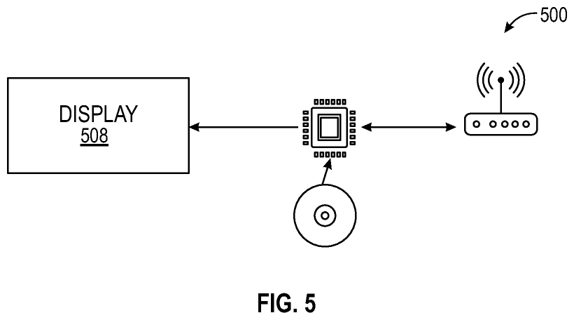

Now referring to FIG. 5, an exemplary embodiment of a playback system 500 is illustrated. In an embodiment, and without limitation, playback system 500 may include a network connection to receive a stream. In an embodiment, and without limitation, network connection may include a wired and/or wireless network. In an embodiment, and without limitation, devices operating on playback system 500 may be capable of playing media from a local storage. In another embodiment, and without limitation, devices operating on playback system 500 may receive the bitstream over a network and/or from a local storage and decode the audio, video, subtitle, and/or other included streams. In an embodiment, and without limitation, the pixels decoded and/or reconstructed by the device and/or processor may be sent to a display unit 508. As used in this disclosure a “display unit” is device and/or system capable of displaying an image and/or video. For example, and without limitation, display unit may include a screen, window, and the like thereof. In an embodiment, and without limitation, playback system 500 may be capable of streaming video that originates at data centers in applications such as, but not limited to on-demand video streaming and/or live broadcast like applications. In this embodiment, video content may be encoded one and streamed and/or saved at a data center. In the same embodiment, encoded video may then be streamed and/or played a plurality of times. For example, and without limitation, in conversational applications such as video conferencing, video may be captured and streamed live between peers participating in the video conferencing sessions. In an embodiment, and without limitation, playback system 500 may use a video bridge that may receive video from participants and then distribute the video to the individuals. In an embodiment, and without limitation, playback system may include a data center, network distribution, and/or playback device. In an embodiment, and without limitation, a data center may keep servers running to respond to requests for video streams. When a video is requested, the server may begin transmitting that video over a network. The streamed video may use one or more networks before reaching the consumer device. Playback devices such as TVs and/or mobile phones may decode and display the video. The energy consumed by the data center may depend on the bitrate of video being stored. For the same amount of content, using higher bitrate may require more storage and servers at the data center and hence consumes more energy. Similarly, energy consumed by network distribution tasks may depend on the bitrate of video being streamed. Higher bitrate requires larger amount of network resources and hence higher energy consumption compared to lower bitrate video. On playback devices energy may be consumed by decoding tasks as well as device display. Energy consumed by video decompression/decoding may depend on the video bitrate as well, with lower bitrate video taking lower energy than higher bitrate video. In an embodiment, and without limitation, playback system 500 may be configured to keep the bitrate as low as possible to achieve a target quality such that streaming solutions may be allowed to produce lower energy consumption. Energy consumption can be significantly reduced with methods that can reduce the bitrate of video that already been encoded. In an embodiment, and without limitation, playback system 500 may be configured to reduce video bitrate by including supplemental information in video bitstreams as described above, in reference to FIGS. 1-4. In an embodiment, supplemental information can signal portions of a video that can be skipped with a predictable impact on the end use experience (quality of experience).

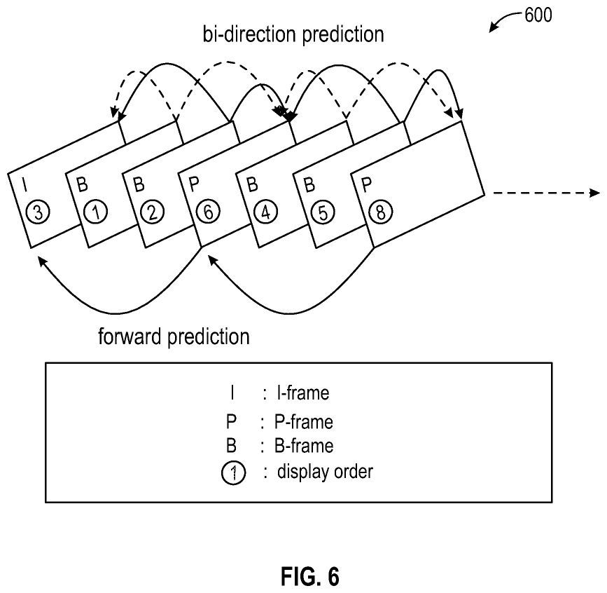

Now referring to FIG. 6, an exemplary embodiment of predictive coding 600 is illustrated. In an embodiment, and without limitation, predictive coding 600 may exploit the similarities among successive frames of a sequence to compress the sequence. In another embodiment, and without limitation, predictive coding may predict the current frames being encoded as a function of predictions from previously encoded frames. At the receiver/decoder, previously decoded frames may be used to form predictions for the current frame being decoded. In an embodiment, frame dependency may include an I-frame, wherein an I-frame is a frame of a video that can be correctly decoded without depending on any other frame. In another embodiment, and without limitation, frame dependency may include a P-frame, wherein a P-frame is a predictively coded frame that depends on one or more frames that are previously decoded. In an embodiment, and without limitation, a P-frame usually depends on frames that are temporally in the past. In another embodiment, and without limitation, frame dependency may include a B-frame, wherein a B-frame is a predictively coded frame that depends on one or more frames that are previously decoded. In an embodiment, and without limitation, a B-frame usually depends on frames that are both temporally in the past and in the future. For example, and without limitation, to support prediction for B-frames, frames may be encoded out of order. For example, and without limitation, predictive coding may determine that a display order of frames may include frames being displayed in the order of 1, 2, 3, 4, 5, 6, 8, wherein the encoding and/or decoding order may be comprised of the arrangement 3, 6, 1, 2, 8, 4, 5, wherein frame 1 may depend on frames 3 and 6, frame 2 may depend on frames 3 and 6, frame 3 may not depend on any additional frames, frame 4 may depend on frames 6 and 8, frame 5 may depend on frames 6 and 8, frame 6 may depend on frame 3, and frame 8 may depend on frame 6. In an embodiment, and without limitation, none of the frames depend on frame 1 and 2 for decoding, wherein dropping frame 4 and 5 will not affect the decoding of any other frame in the sequence. This may indicate that frame 3 is displayed in place of frames 4 and 5. In an embodiment, and without limitation, the impact of displaying 3 may depend on content. For example, and without limitation, fast moving content such as sports action may be perceived as jerkiness of jitter played in the video, wherein static content such as video may not be perceived with any modifications. In another embodiment, and without limitation, dropping frame 6 may impact decoding of frames 1, 2, 4, 5, and 8. In this embodiment, decoders may use error concealment methods to fill in the missing information from other available frames, wherein error concealment is described above, in reference to FIGS. 1-6. In an embodiment, and without limitation, the quality of experience, such as but not limited to whether users notice or are bothered by distortions caused by error concealment, may depend on the content, amount of concealment, and/or the type of concealment. For example, and without limitation, for fast moving content such as sports action, users may perceive blocking or patches in the played video, wherein for static content such as video conferencing users may not notice any difference. Additionally or alternatively, frames can be dropped at the data center, in the network nodes, and/or at the consumer device. The impact of quality on frame dropping may depend on video content, frame dependencies, magnitude of dependencies, and error concealment. In an embodiment, predictive coding may determine the encoding and decoding order as a function of the frame dependency and the display order, wherein determining is described above, in reference to FIGS. 1-5.

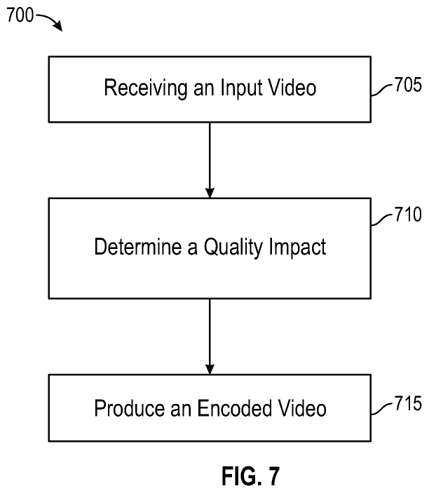

Now referring to FIG. 7, an exemplary embodiment 700 of a method for predictive coding is illustrated. At step 705 a computing device 304 receives an input video 308. Computing device 304 may include any of the computing device 304 as described above, in reference to FIGS. 1-6. Input video 308 may include any of the input video 308 as described above, in reference to FIGS. 1-6.

Still referring to FIG. 7, at step 710, computing device 304 determines a quality impact 308. Quality impact 308 may include any of the quality impact as described above, in reference to FIGS. 1-6. Computing device 104 determines quality impact 308 as a function of identifying a frame drop indicator 312 as a function of input video 308. Frame drop indicator 312 may include any of the frame drop indicator 312 as described above, in reference to FIGS. 1-6.

Still referring to FIG. 7, at step 715, computing device 304 produces an encoded video 316 as a function of an encoding process 320. Encoded video 316 may include any of the encoded video 316 as described above, in reference to FIGS. 1-6. Encoding process 320 may include any of the encoded process as described above, in reference to FIGS. 1-6.

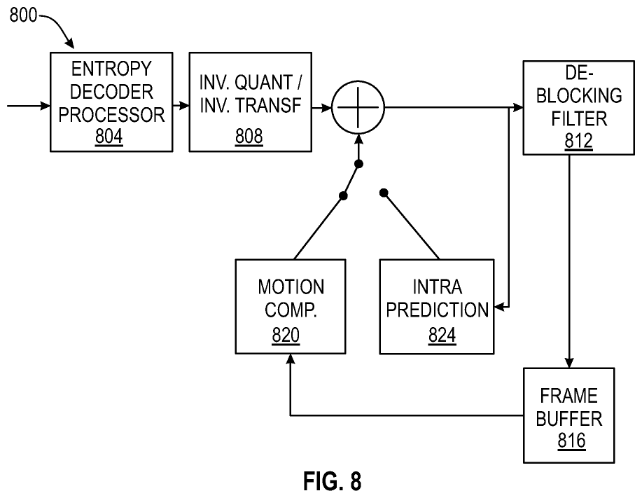

FIG. 8 is a system block diagram illustrating an example decoder 800 capable of adaptive cropping. Decoder 800 may include an entropy decoder processor 804, an inverse quantization and inverse transformation processor 808, a deblocking filter 812, a frame buffer 816, a motion compensation processor 820 and/or an intra prediction processor 824.

In operation, and still referring to FIG. 8, bit stream 828 may be received by decoder 800 and input to entropy decoder processor 804, which may entropy decode portions of bit stream into quantized coefficients. Quantized coefficients may be provided to inverse quantization and inverse transformation processor 808, which may perform inverse quantization and inverse transformation to create a residual signal, which may be added to an output of motion compensation processor 820 or intra prediction processor 824 according to a processing mode. An output of the motion compensation processor 820 and intra prediction processor 824 may include a block prediction based on a previously decoded block. A sum of prediction and residual may be processed by deblocking filter 812 and stored in a frame buffer 816.

In an embodiment, and still referring to FIG. 8 decoder 800 may include circuitry configured to implement any operations as described above in any embodiment as described above, in any order and with any degree of repetition. For instance, decoder 800 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

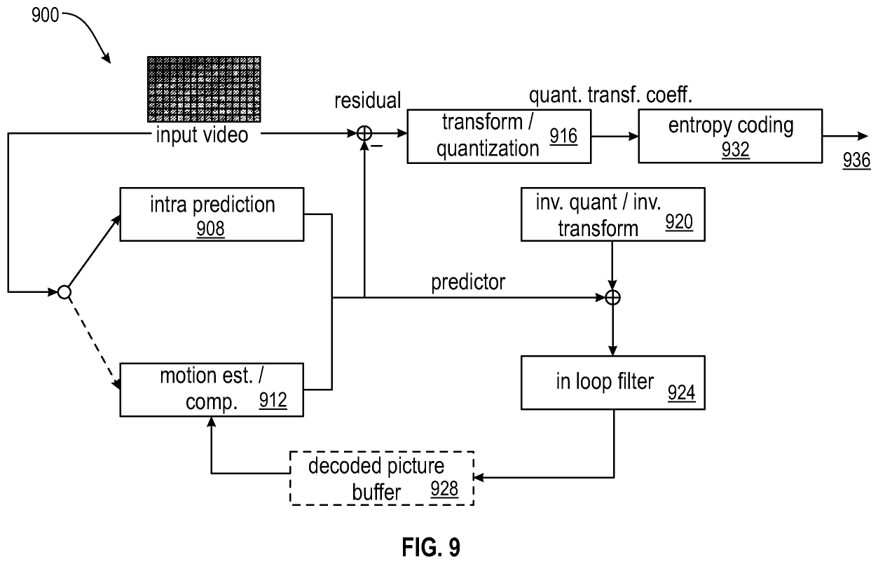

FIG. 9 is a system block diagram illustrating an example video encoder 900 capable of adaptive cropping. Example video encoder 900 may receive an input video 904, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 9, example video encoder 900 may include an intra prediction processor 908, a motion estimation/compensation processor 912, which may also be referred to as an inter prediction processor, capable of constructing a motion vector candidate list including adding a global motion vector candidate to the motion vector candidate list, a transform/quantization processor 916, an inverse quantization/inverse transform processor 920, an in-loop filter 924, a decoded picture buffer 928, and/or an entropy coding processor 932. Bit stream parameters may be input to the entropy coding processor 932 for inclusion in the output bit stream 936.

In operation, and with continued reference to FIG. 9, for each block of a frame of input video, whether to process block via intra picture prediction or using motion estimation/compensation may be determined. Block may be provided to intra prediction processor 908 or motion estimation/compensation processor 912. If block is to be processed via intra prediction, intra prediction processor 908 may perform processing to output a predictor. If block is to be processed via motion estimation/compensation, motion estimation/compensation processor 912 may perform processing including constructing a motion vector candidate list including adding a global motion vector candidate to the motion vector candidate list, if applicable.

Further referring to FIG. 9, a residual may be formed by subtracting a predictor from input video. Residual may be received by transform/quantization processor 916, which may perform transformation processing (e.g., discrete cosine transform (DCT)) to produce coefficients, which may be quantized. Quantized coefficients and any associated signaling information may be provided to entropy coding processor 932 for entropy encoding and inclusion in output bit stream 936. Entropy encoding processor 932 may support encoding of signaling information related to encoding a current block. In addition, quantized coefficients may be provided to inverse quantization/inverse transformation processor 920, which may reproduce pixels, which may be combined with a predictor and processed by in loop filter 924, an output of which may be stored in decoded picture buffer 928 for use by motion estimation/compensation processor 912 that is capable of constructing a motion vector candidate list including adding a global motion vector candidate to the motion vector candidate list.

With continued reference to FIG. 9, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 9, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 9, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 9, encoder 900 may include circuitry configured to implement any operations as described above in any embodiment, in any order and with any degree of repetition. For instance, encoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 900 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 9, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 900 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

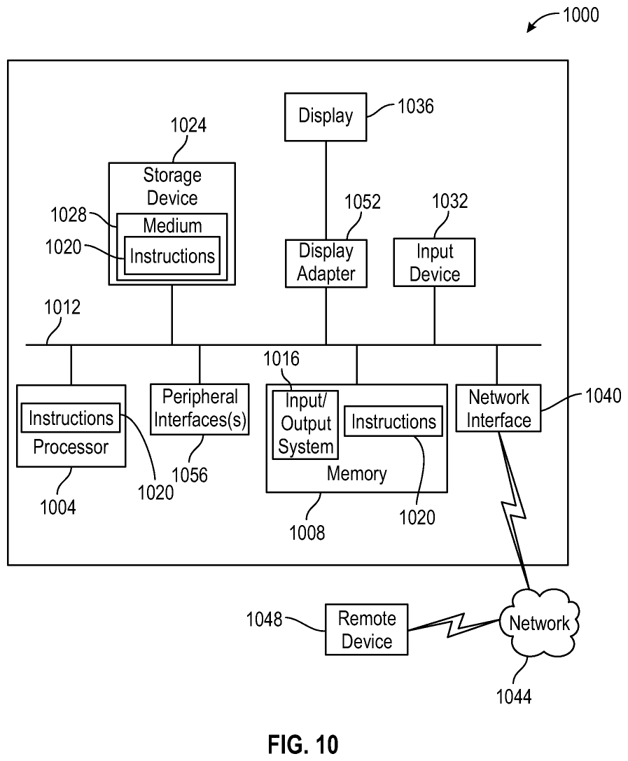

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC)

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for predictive coding, wherein the system comprises a computing configured to:
receive an input video;
determine a quality impact as a function of the input video, wherein determining the quality impact further comprises:
identifying a frame drop indicator as a function of the input video; and
determining the quality impact as a function of the frame drop indicator; and
produce an encoded video as a function of the quality impact and an encoding process.

2. The system of claim 1, wherein identifying the frame drop indicator further comprises:
determining a mean opinion score as a function of the frame drop indicator; and
identifying the frame drop indicator as a function of the mean opinion score.

3. The system of claim 1, wherein identifying a frame drop indicator further comprises:
receiving a display order; and
identifying the frame drop indicator as a function of the display order.

4. The system of claim 1, wherein the frame drop indicator includes a frame dependency.

5. The system of claim 1, wherein identifying the frame drop indicator further comprises:
performing a predictive encoding protocol; and
identifying the frame drop indicator as a function of the predictive encoding protocol.

6. The system of claim 1, wherein identifying the frame drop indicator further comprises:
determining a transport packet as a function of the input video; and
identifying the frame drop indicator as a function of the transport packet.

7. The system of claim 1, wherein encoding the input video further comprises initiating a frame drop protocol.

8. The system of claim 7, wherein initiating the frame drop protocol further comprises:
determining a reduced quality as a function of the quality impact; and
initiating the frame drop protocol as a function of the reduced quality.

9. The system of claim 7, wherein initiating the frame drop protocol further comprises performing an error concealment.

10. The system of claim 9, wherein performing the error concealment further comprises:
determining a proximal frame; and
performing the error concealment as a function of the proximal frame.

11. A method for predictive coding, wherein the method comprises:
receiving, by a computing device, an input video;
determining, by the computing device, a quality impact as a function of the input video, wherein determining the quality impact further comprises:
identifying a frame drop indicator as a function of the input video; and
determining the quality impact as a function of the frame drop indicator; and
producing, by the computing device, an encoded video as a function of the quality impact and an encoding process.

12. The method of claim 11, wherein identifying the frame drop indicator further comprises:
determining a mean opinion score as a function of the frame drop indicator; and
identifying the frame drop indicator as a function of the mean opinion score.

13. The method of claim 11, wherein identifying a frame drop indicator further comprises:
receiving a display order; and
identifying the frame drop indicator as a function of the display order.

14. The method of claim 11, wherein the frame drop indicator includes a frame dependency.

15. The method of claim 11, wherein identifying the frame drop indicator further comprises:
performing a predictive encoding protocol; and
identifying the frame drop indicator as a function of the predictive encoding protocol.

16. The method of claim 11, wherein identifying the frame drop indicator further comprises:
determining a transport packet as a function of the input video; and
identifying the frame drop indicator as a function of the transport packet.

17. The method of claim 11, wherein encoding the input video further comprises initiating a frame drop protocol.

18. The method of claim 17, wherein initiating the frame drop protocol further comprises:
determining a reduced quality as a function of the quality impact; and
initiating the frame drop protocol as a function of the reduced quality.

19. The method of claim 17, wherein initiating the frame drop protocol further comprises performing an error concealment.

20. The method of claim 19, wherein performing the error concealment further comprises:
determining a proximal frame; and
performing the error concealment as a function of the proximal frame.
